(19) United States
(12) Patent Application Publication
(10) Pub. No.: US 2006/0218615 A1
(43) Pub. Date: Sep. 28, 2006

(54) Developing and delivering audio or audiovisual presentations including rehearsals

(76) Inventors: Johnny Caswell, Burbank, CA (US); Jan Parent, Burbank, CA (US); Roger Paglia, Burbank, CA (US); Howard Livingston, Burbank, CA (US)

Correspondence Address: GREENBERG TRAURIG LLP, 2450 COLORADO AVENUE, SUITE 400E, SANTA MONICA, CA, 90404, US

(21) Appl. No.: 11/085,879

(22) Filed: Mar. 22, 2005

(51) Int. Cl. H04N 7/16; H04N 7/173; H04N 5/222

(52) U.S. Cl. 725/114; 725/144; 348/722

(57) ABSTRACT

Audio or audiovisual material not previously distributed to the public is made available for licensing or worldwide distribution by way of a retail market by Internet, home video devices and television-based distribution. Rehearsals of events, and novel content, including practice sessions, musical clinics and related educational material may be recorded and distributed in advance of, contemporaneous with, or following the events with open or closed circuits, and with remote locations connected in real-time or otherwise on a time-delayed basis.

A portion of the disclosure of this patent document contains material which may be subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

The present disclosure relates to creating commercially distributable vehicles based on the practicing of subject matters preparatory to performing them for fine arts and other performances available through electronic media, for example by way of the Internet. In particular, the present invention relates to audio or audiovisual rehearsal material made available for distribution to a retail market by conventional and later developed technologies including but not limited to, the Internet, and home video devices, in addition to other and further channels of distribution.

### BACKGROUND OF THE DISCLOSURE

It is difficult to gauge either the subjective entertainment value or the commercial value of fine arts and other types of performances. It is likewise challenging to measure optimal ways to appreciate, enjoy, study or even commercially exploit practice events, or rehearsals leading up to such performances before they take place, when they occur, and over time. For example, if one were to consider even briefly momentous performances and then evaluate the value of the practice sessions and the rehearsal sessions leading up to those events an interesting picture would emerge. The instant disclosure provides for new ways to appreciate and understand these and a host of related issues related to packaging audio or audiovisuals signals and packaging commercial versions of the same. The present disclosure also provides a new way for entertainment consumers to have access to a virtually untapped potential set of sources of performances. This large subset of generally un-presented or artistically developed, collated and distributed activities likely has a substantial value both to casual consumers and those who are considered to be aficionados (or ‘fans’) of audio, audiovisual and related entertainment or fine art performances.

An illustrative but not limiting example of the teachings of the present disclosure is found in providing access to rehearsal footage compiled while practicing for major entertainment or fine art performance events. This example is discussed in detail below but is offered for consideration solely to explain aspects of the instant disclosure. Any such new form of footage, for example, would be able to provide for the consuming public heretofore unavailable views of popular or otherwise noteworthy performers in advance of, contemporaneous with, or after the major entertainment or fine art performance events themselves.

According to the current disclosure a novel mechanism is presented to offer, keeping with this example, a novel subscription-based access to rehearsal footage. This disclosure could be manifested in various forms, such as exclusive, unseen and unheard footage of the GRAMMY® Award presenters and nominated artists in advance of the GRAMMY® Awards telecast. The present disclosure contemplates such mechanisms, as described in further detail here, illustrated in the associated figures and claimed below. Many examples highlight both the current absence of, and tremendous potential value of, providing a solution to this longstanding need. These examples also suggest strongly that there has neither been a commercially viable attempt made to address the teachings of the present disclosure, nor any realistic attempt made to frame the problem as done herein.

Although not addressed by the prior art, a growing awareness of the value of rehearsal footage is further underscored by plethoric examples from the recording industry. To take a simple example, in 1991 an album (NEVERMIND, David Geffen Records, Universal Music & Video Distribution Corp.) was released by the band NIRVANA, featuring vocalist Kurt Kobain, which was generally acknowledged as a paradigm shifting piece of then contemporary music, bridging the gap from the “punk” to the “grunge” type rock of music.

In strictly commercial terms, the recording was extremely successful. Artistically speaking, the popular rock-an-roll journalistic community rated the recording as among the top three of such types of recordings in the last three decades. In the three year period which followed, Kobain subsequently died under mysterious circumstances, leading to a conclusion that he had taken his own life, in the tradition of other domestic rock music ‘icons’ from Janis Joplin, Keith Moon and Jimi Hendrix through Jim Morrison. While this infamy may have impacted Kobain's value as contemporary music performance artist or in general as an entertainment figure, it also created interest as to his talent level and musical judgment as a putative artist, in some sectors. Without “behind the scenes” access his legacy likely would have followed him to his heroin fueled demise, and buried with him any lingering doubts as to what he may have accomplished.

In commercial terms, management of the small catalog of NIRVANA tracks could have been used as a value driver in subsequent years, but it seems to have been largely neglected. Diminishing returns were reflected in the profits garnered for each year of the next ten years by their remaining recorded legacy. While the final performance of NIRVANA was in late 1994, release of a four Compact Disc collection was focused around a plurality of previously unreleased rehearsal tracks under the title WITH THE LIGHTS OUT (2004, David Geffen Records, Universal Music & Video Distribution Corp.) and was a profound commercial success, selling greater than 2 million copies within the first three months of its release.

Comparison of the sales of this recording set with the sets of prior and unquestionably higher fidelity versions of much of the same catalog of sound recordings of the same band in the last decade, militates for the extremely difficult ability to quantify the value of rehearsals. Some would even suggest that those wanting to understand, by studying the historical musical context, the nature of any alleged artistic creation were enabled by this compilation largely of unreleased rehearsals. Beyond dispute is that the other sides of performance artists, that are often only captured by inadvertence, serendipity and while learning, perfecting and practicing their crafts have an unrealized potential to add tremendous value to the coffers of those who engage in retail distribution of the same. Until the advent of the instant disclosure this was not something that commercial reality had driven into an access vehicle. Using the Internet, and known technical tools, the instant disclosure stands to change this.

The precise driver of the value of rehearsals to consumers is likely as multi-faceted and subjective as the litany of reasons why people enjoy audio or audiovisual performances and recordings in the first place. There is no indication of prior art, or any published understanding of the nature of this issue. Likewise, no product, service or known project in this area has satisfied the longstanding needs that fans (and others) potentially have for the access to, and the ability to acquire, enjoy and share rehearsal footage. Accordingly the present disclosure is offered for consideration to address this issue, and provide for a way to, for example, make retail distribution of such content a reality. With the Internet and a knowledge of practicing of audio or audiovisual presentations preparatory to performing or presenting them, this can now be ameliorated.

### SUMMARY

Briefly stated, audio or audiovisual material not previously distributed to the public is made available for licensing and/or worldwide distribution to a retail market by Internet, home video devices, and television based distribution. Rehearsals of events may be recorded and distributed in advance of, contemporaneous with, or following the events with open or closed circuits, and with—using conventional technology, remote location software program and a logic architecture which enables people from any location in the world with access to the Internet to receive and transmit information, or at least to access it on a subscription or other retail basis, at home in front of their television sets, at work, or wherever they happen to be.

According to embodiments of the present disclosure, those having subscriptions, otherwise paying for and signing up for the described service—and, in general, consumers seeking entertainment at any time of day or night can participate by accessing desired content or footage of their favorite performers, artists, or those whom they wish to study, understand or appreciate in the process of perfecting their respective crafts, among other featured items.

Communicating between a remote party and a central database processing resource through a computer network is also done, in embodiments of the instant disclosure, by subscription, and those skilled in the art understand that this further includes for example, the known steps of providing credit card information of a remote user prior to providing the data, and data being transferred to the remote user after charging a credit card for such data. Monies, for example as conventionally known, can be transferred electronically via a telecommunications line between respective financial entities related to the remote party and to an operator of the central database. Since such transactional practices are known to artisans, further discussion of them is not included, rather incorporated expressly by reference herein, see, for example U.S. Pat. No. 6,240,415 which is expressly incorporated herein as if fully set forth in this specification.

Remote participants interacting in real time or near-real-time with significant and important events, functions, rehearsals or other entertainment events, and/or fine art productions before, after, or during the ongoing processes of such productions are expressly contemplated by the teachings of the present disclosure. The participants may respond to ongoing choices for different rehearsals of shows or movies by watching in a remote location via a transmission to the participants' television monitor, or the computer screen itself. The audio or audiovisual signals could be sent on a network such as the Internet or by way of cable distribution networks, alone or in combination with other methods within the normal skill level or artisans.

Likewise, as conventionally known, the telecommunication data or signals may be a television source which is different from or connected to a computer terminal for responding, or the situation can be contained in a single monitor device, for instance the Web TV™ brand of system, or related or known systems for transmitting or transferring audio and/or audiovisual signals, or data.

It is further contemplated that rehearsals of a desired event can be broadcast in an open circuit or closed circuit sense to subscribers, remote participants, or any manner of Internet based, on-line users who then respond in the real-time or near-real-time frame, in addition to conventional time delays, time shifting and the accessing of pre-recorded banks and data sets of rehearsal content stored in the most appropriate media. Those skilled in the audio or audiovisual arts understand this to embrace any known or later developed electronic storage media.

The present inventors have created a process for developing and posting audio and audiovisual footage through the Internet which further includes providing an automatically functional recording environment including a plurality of staging areas, collecting at least one of an audio and/or an audiovisual set of data signals from at least one of the plurality of staging areas, reviewing the collected data signal set at a production facility, optionally editing one data signal set, and approving the data signal set for distribution in addition to be able to post the resulting data signal set on the Internet, subject to licensing restrictions, requirements and artist approvals, as needed.

A process for developing and posting audio or audiovisual footage of an entertainment event preparatory to performing it in public or of content from a private meeting of performers held for this purpose, on the Internet, comprising the steps of collecting at least one of audio and audiovisual data from a rehearsal, reviewing the data to create a packet of transmittable signals effective to publish in an electronic medium such as the Internet, processing the packet of transmittable signals in at least one of a production and an editing facility, and publishing the resulting audio or audiovisual rehearsal footage through an electronic medium such as the Internet is likewise part of the instant disclosure. Further contemplated is the processing step further comprising garnering electronic or written permission from the performers for the publication of the subject rehearsal footage and electronically verifying compliance with licensing or distribution agreements in real-time.

The process for developing and posting audio and audiovisual footage through the Internet expressly includes the involved set of data signals being a rehearsal for a subsequent fine arts performance event, or related performance, and the practice sessions leading up to the same, be they formal, informal or spontaneous.

The process for developing and posting audio and audiovisual footage through the Internet on a retail basis also contemplates the step of providing access on a subscription-basis to Internet users, or using related mechanisms to make any involved types of content available.

By offering for consideration aspects of, for example, sectors of the popular music business which have not been readily available on a subscription, or other known basis prior to this time, the instant disclosure satisfies a longstanding need that has not been squarely addressed. Nothing published or otherwise disseminated for utilization on a commercial basis has been developed which speaks to novel aspects of the instant disclosure in terms of generating and commercially exploiting rehearsal materials (audio or audiovisual disclosure in particular) not previously distributed to the public. Rehearsals are a unique vehicle of expression, and by providing almost universal access to the same on a retail basis it is respectfully proposed that the instant disclosure constitutes progress in science and the useful arts.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 provides an overall, generalized and schematic view of an Internet/Web-related system for gathering, and distributing of desired audio or audiovisual data according to an embodiment of the present disclosure;

FIG. 2A is a further schematic treatment of detailed aspects of an Internet/Web-related system for gathering, and distributing rehearsal data according to an embodiment of the present disclosure; and

FIG. 2B provides further schematic details on aspects of an Internet/Web-related system for gathering, and distributing rehearsal data according to an embodiment of the present disclosure.

FIG. 3 illustrates the receiver side of an illustrative Internet/web-related rehearsal data distribution system.

### DETAILED DESCRIPTION OF THE DISCLOSURE

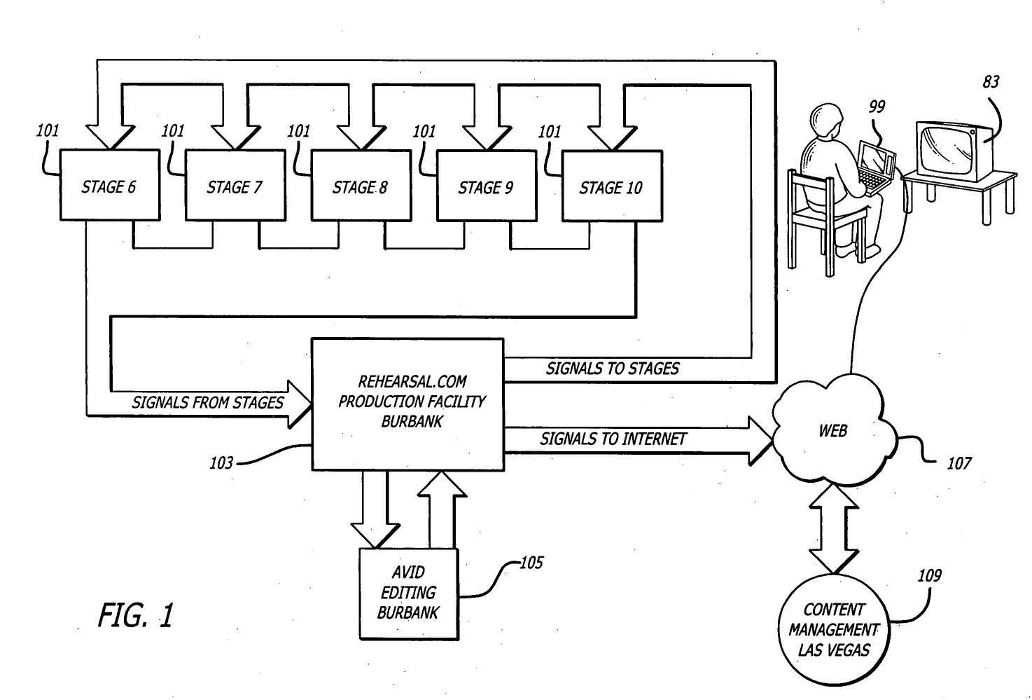

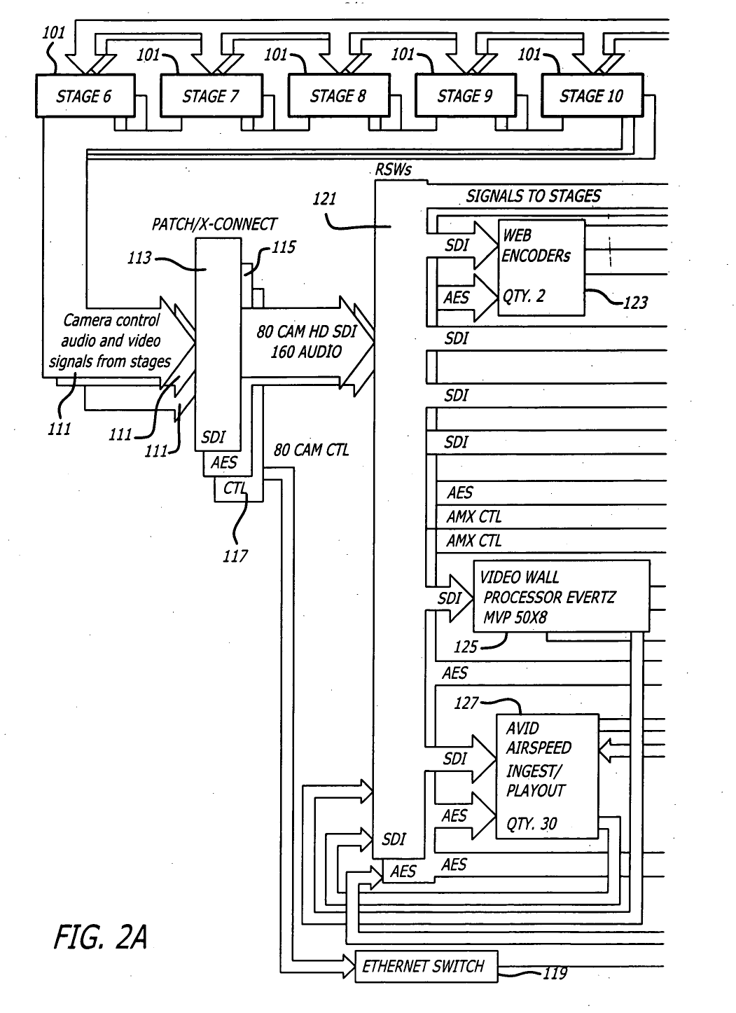

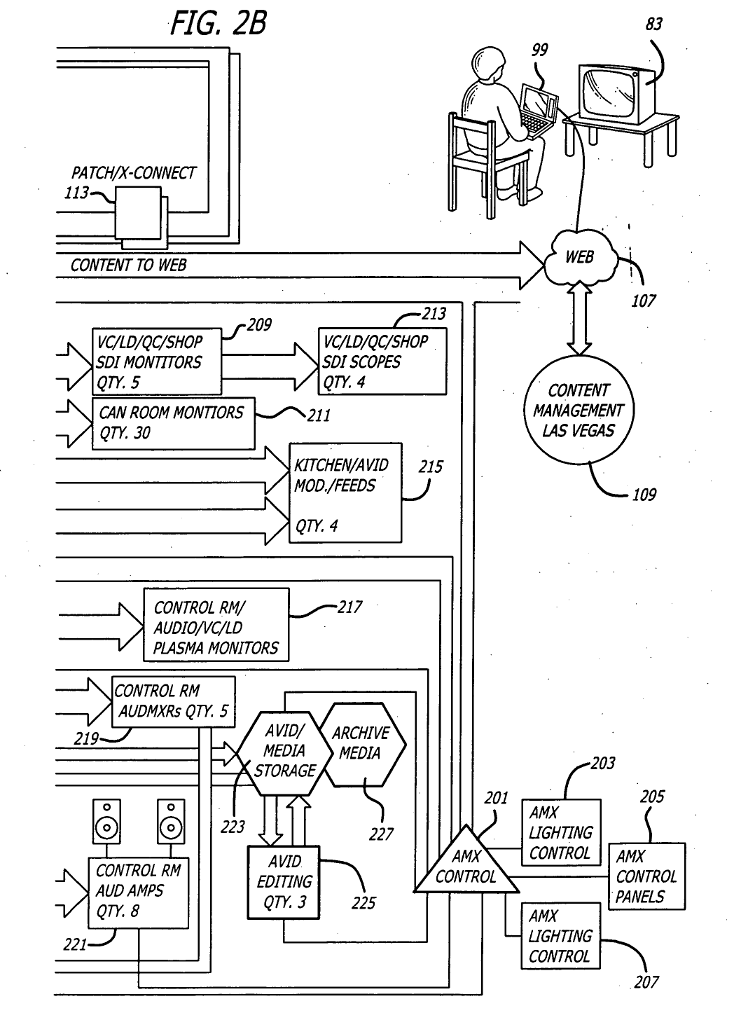

According to the Oxford English Dictionary, a rehearsal is defined as: a. The practicing of a play or musical composition preparatory to performing it in public; a private meeting of actors or performers held for this purpose (http://dictionary.oed.com). [Emphasis added.] For the purposes of the instant specification this definition is expressly incorporated by reference. The present inventors have discovered that rehearsals, made available through the Internet, create an uncanny ability for consumers of popular culture to engage in a new manner of multi-tasking, namely watching a private meeting of performers practicing their craft contemporaneous with the performance event for which their ongoing series of recountings, recitals, and repetitions have been undertaken. This is shown both in FIG. 1 and FIG. 2B where consumers watch television while being on-line with their lap-top computers 99 viewing a previously recorded rehearsal event which was made prior to the entertainment event being shown on their television sets 83.

By addressing the longstanding need to create, harvest, distribute and generally provide for example, rehearsal footage for various purposes and in various formats an entirely new aspect of ways to appreciate, understand, and offer retail marketing and distribution opportunities for the performing arts is herein offered for consideration. In sum, the present inventors have uncovered numerous unexpected benefits which arise for both subscribers and vendors while showing a subscribing Internet audience, and others who become involved on a retail basis, a side of the performance artist that has never been accessible before.

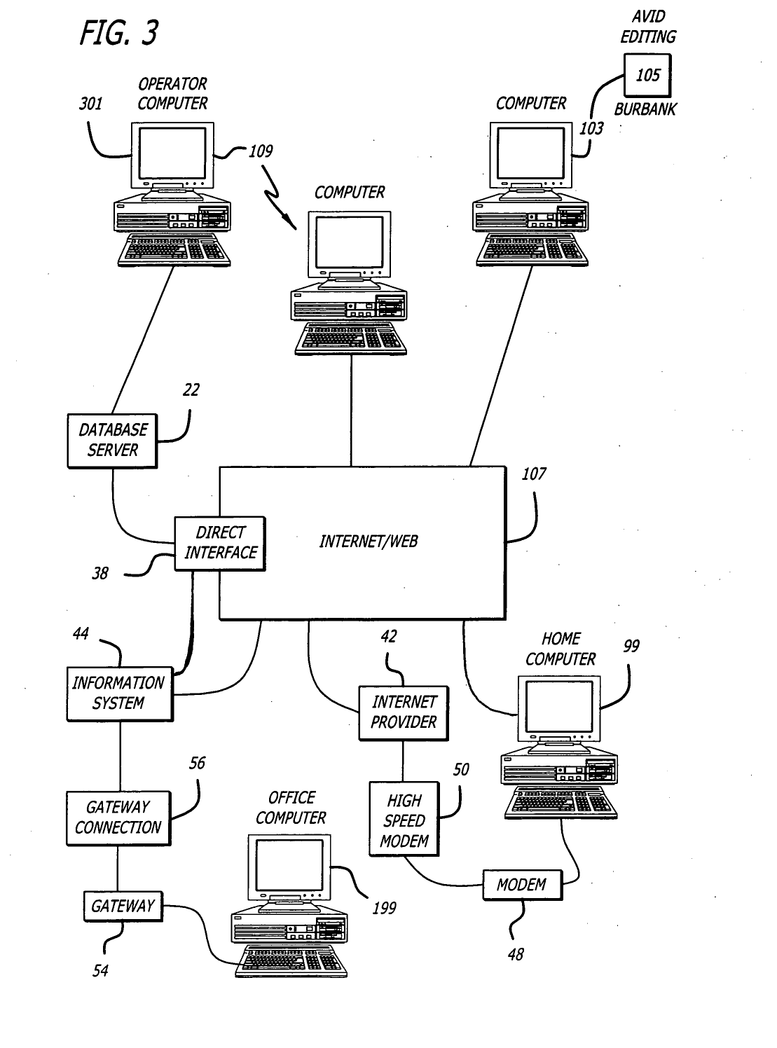

For example, the content or footage from a “behind closed doors” rehearsal is available to access on a retail basis. Making this available according through known Internet systems, as discussed above, is incorporated by reference as if fully set forth here from U.S. Pat. No. 6,240,415. See, for example, FIG. 3 for receiver-side descriptions of this.

In contradistinction to known systems, this process has aspects that are both planned and spontaneous and stands likely to endear artists even more to their fans in an entertaining, informational and even inspirational manner. The intangible value of rehearsals, as highlighted above, remains challenging to quantify, and ostensively provides vast commercial potential. This is de-limited by the teachings of the present disclosure, which provide a new way for fans to be closer to their artists of choice.

One approach used in conjunction with the present disclosure involves collecting audio and/or audiovisual data in an optimized rehearsal studio. Such optimized rehearsal studios may include, for example, any desired number of unmanned high definition cameras and hanging dialog microphones. Additional lighting is optimized, for example may be kept to a minimum so as to not distract the performers, for example musicians and technical crew.

With no video crew required to be in the studio, the integrity of an artist's rehearsal space does not have to be compromised. Without traditional constraints, artists can experiment, stretch the envelopes of their creative abilities and create works that may arise more readily than traditionally pre-determined or later selected staged performances. According to one example, further discussed below, the artist and management may then review the involved material and agree upon the way that it is to be posted, and then designate a desired version of a rehearsal or performance for retail distribution or direct posting to the Internet on a subscription basis.

Referring now to FIG. 1, a schematic is shown which depicts an exemplary mode of operation according to an embodiment of the instant teachings. According to this example, the performing artists are captured in the creative environment of an optimized rehearsal studio. Individualized aspects of such a studio are able to be controlled, based upon the performances involved, or standardized in a universal fashion. For the purposes of this example, the latter is used for ease of discussion.

A plurality of stages 101, are made available for performance artists to use, with sets of data collected and selectively processed at a desired production facility 103. Likewise, editing of the footage may be done at another facility 105, and then returned to production facility 103 to be routed back to any of the plurality of stages 101 for review, revision and supplementation directly, or by way of the Internet including appropriate web servers, firewalls, related databases, banking systems, database servers and those conventional items designated generally as web 107. Receiver side distribution includes a user accessing rehearsals on (wireless, or cord-based unit) for example a lap-top computer (or personal computer, personal digital assistant, video-phone etc.) 99, while watching the performance event on a television set 83 for which the rehearsals were done, for example.

Similarly, remote content management 109 relates conventionally to the web 107 and those services required to facilitate communication in this loop, including any of the required stages 101, production facility 103, editing location 105, content management site and web 107. See, for example, U.S. Pat. No. 6,240,415 expressly incorporated by reference as if fully set forth herein, as FIG. 3.

A further aspect of the instant disclosure involves using the technology for development of talent, educational or teaching services. The present inventors are, for example, committed to using embodiments of the instant disclosure for nurturing new talent through a series of ongoing clinics. Varied instruments including, but not limited to drums, keyboards, guitars or any instrument, generally may have an audience that is both eager and enthusiastic to learn new techniques, develop professional skills and learn the so-called “ins and outs” of the music profession.

By providing access to rehearsal footage and content, among other things, the disclosures of the present invention can open up novel educational horizons and de-limit the possibilities for training, orientation, practice and learning of new techniques. For example, subscribing Internet users can gain access to a series of clinics done in their areas of interest musically, by artist, instrument or content.

Another contemplated way to use the present disclosure to facilitate educational and training-based objective is to, for example, feature some of the more accomplished musicians in the world in complement with, or on a discrete basis apart from rehearsal content. This could be done in the form of candid interviews, professional demonstrations or any manner of question and answer sessions. Likewise, doing so with an invited audience could serve to give viewers using the technology of the instant disclosure either an educational or an inspirational experience.

The present inventors further contemplate reaching out to technical and musical engineering personnel as well as management and touring staff to offer information on other aspects of the music business to Internet-based subscribers, and others. Among the goals of the present disclosure include inculcating an audience with musical rudiments and fundamentals so that they can be able to absorb useful and practical knowledge that could help them along with their respective musical careers.

### Example

Exclusive, unseen and unheard footage of the 2006 GRAMMY® Awards presenters and nominated artists in advance of the GRAMMY® Awards telecast is contemplated by the present inventors. This working example is illustrative of the present disclosure, although artisans shall readily understand how it applies to different events, happening and for where artistic expression can be captured.

In advance of the GRAMMY® telecast a variety of the artists performing for the 48th annual music awards show will run through their performances, within for example, the optimized staging area mentioned above. Likewise, this can be done before the rehearsals.com array of high definition Panasonic® cameras, or similar devices which are designed for capturing practice sessions with a minimum of artifactual interference.

The footage is then, for example, produced and encoded into Windows Media Video® type of format for easy viewing by the music fans over the Internet who log on to the rehearsals.com web site, http://www.rehearsals.com (Available from Rehearsals.com of Burbank, Calif.).

Further, according to the example, the site may also feature exclusive news coverage from where the musicians practice and rehearse, as well as being the home for interactive reader polls and new and original blog content, all directly through the proprietors according to the teachings of the present disclosure, from musicians and critics alike. For example, as shown in FIG. 1, a plurality of stages are housed in the studio which features a 150,000 square foot ‘state of the art’ and world class digital high definition production facility. The facility features in this illustrative example, at least five recording studios, each outfitted with 12 robotic High Definition Panasonic® cameras and Shure® brand of microphones, with the ability to supply up to sixteen feeds to remote viewing locations.

Further, according to this exemplary embodiment of the instant disclosure artists can access this all in addition to at least three video and audio edit bays, more than one Pro-Tools® brand of sweetening room, at least a lighting director's room, and at least a video control booth placing the proprietor in this example, rehearsals.com in a position to host the artists the way they want to be, and portray them the way they naturally are, all the while insuring the integrity of the creative environment is maintained.

With, for example, an at least twenty seat robotic camera control room, the rehearsals.com crew can view any desired number of artist's rehearsals from many angles and perspectives, giving a unique glimpse into how any number of events including a series of the eventual live appearances will look before the artists' performances actually begin. Additionally, rehearsals.com can provide a feed to fans, label executives and reviewers at the same time, thus enabling advance screenings of tours and related types of events before they actually begin. Real-time, substantially real-time and desired time delays are also contemplated according to the present disclosure.

In addition to the studios, the exemplary facility houses a 25,000 square foot soundstage used for tour and awards show pre-production. This facility has access to one of the nation's largest supplies of musical performance equipment in one place, with over 9,000 square feet of musical instruments, production and stage ready lights and sound equipment, with professional support for the artist, musician and audio professional. For ease of discussion, the exemplary embodiment visited below is discussed using those technical abbreviations as would be known to artisans taken in conjunction with the descriptions above and the claims below.

Turning now to FIG. 2A, each practice performing or rehearsal space, or as illustrated each of the plurality of stages 101 are linked to camera control audio and video signals 111, which patch or cross-connect by means of SDI 113, AES 115, and CTL 117 to RWS's and loop back to each of the plurality of stages 101 and video footage, including at least about 80 camera control signals also link to an ethernet switch 119. Ethernet switch 119 links to master AMX control driver 201 (see FIG. 2B).

At the same time, RSWs 121 can transmit the evolving signals back to any of stages 101, the patch/cross-connect 113. Likewise, web encoders 123, can receive data from any of SDI 113, AES 115, and CTL 117. SDI 113, and AES 115 also feed into at least five VC/LD/QL/SHOP SDI monitors are operatively connected to at least four VC/LD/QC SHOP SDI Scopes 213.

Referring now also to FIG. 2B, and or to FIG. 2A, further details are shown for the process for developing and posting audio or audiovisual footage through the Internet, as discussed, providing recording environment including either one or more or a plurality of staging areas 101, for collecting the audio and an audiovisual set of data signals 111 from at least one of the plurality of staging areas 101, reviewing the collected data signal set at a production facility 103, editing the at least one data signal set 111 happens at monitors 209, scopes 213, CONTROL RM/AUDIO/VC/LD PLASMA MONITORS 217, CONTROL RM AUDMXRS 219 CONTROL RM AUD AMPS 221 and KITCHEN/AVID MD/FEEDS 215.

Likewise the steps of approving the data signal set for distribution, and of posting said data signal set on the Internet happen between the RSW's 121 and Web encoders 123. Before repeating any of the foregoing steps, the signals are processed through AVID/Media Storage 223, some are archived at the Archive media location 227, and the signals are likewise combined and enhanced by way of (AMX) Control 201, (AMX) Lighting Control 207, driven by AMX control panels 205.

Similarly, the method of rehearsal content management by a third party by a performer and having an Internet distribution network is illustrated both in FIG. 1 and FIG. 2A, 2B, and FIG. 3. In FIG. 2B, user accessible Internet signals may be used by any known device, for example be accessed on lap-top computer 99 viewing a rehearsal while watching the performance event for which the artists were practicing on television set 83. A process for providing rehearsal content by generating at least one of audio or audiovisual data signals in any staging area 101, includes transmitting a set of data signals 111, from the described production area to a production facility 103 and an editing site 105, before editing the data signals and forwarding the revised signals back to at least one of the staging area 101 and the Internet 107 and a content management site 109.

Turning to FIG. 3, content management site 109, includes operator computer 301, which may be used, for example with a database server 22, or direct interface 38 by conventional information system 44, gateway connection 56 and/or gateway 54, which connects to—for example office computer 199. Alternately, production facility 103 or content management site 109, sends signals to Internet/web 107, with Internet provider 42 and at least one of modem 48 and high speed modem 50 facilitating connection to home computer, lap-top computer 99, or any other devices desired that can either receive signals or otherwise serve as a remote user interface.

Finally, according to one embodiment of the instant disclosure, by contract it can be agreed that nothing is released in any form unless by a mechanism of the present invention. In other words, electronically or otherwise it may be programmed that one must be able to show, for example, by electronic signature an approval under the present inventors' systems' mechanism. This could be done by a showing that a designee has garnered a record of the explicit consent of the artist. Once this is secured, for example, the system may post the instant subject matter's disclosure, for example, the rehearsal footage to the Internet, this is contemplated electronically or discussed above, and may use conventional means for verifying compliance.

Additional modifications and improvements of the present invention may also be apparent to those skilled in the art. Thus, the particular combination of parts described and illustrated herein is intended to represent only one embodiment of the present invention, and is not intended to serve as limitations of alternative devices within the spirit and scope of the invention.

What is claimed is:

1. A process for developing and posting audio or audiovisual footage of an entertainment event preparatory to performing it in public or of content from a private meeting of performers held for this purpose, on the Internet, comprising the steps of:
collecting at least one of audio and audiovisual data from a rehearsal;
reviewing the data to create a packet of transmittable signals effective to publish in an electronic medium such as the Internet;
processing the packet of transmittable signals in at least one of a production and an editing facility; and
publishing the resulting audio or audiovisual rehearsal footage through an electronic medium such as the Internet.

2. The process of claim 1, wherein the processing step further comprises:
garnering electronic or written permission from the performers for the publication of the subject rehearsal footage and electronically verifying compliance with licensing or distribution agreements in real-time.

3. A process for developing and posting audio or audiovisual footage through the Internet comprising in combination, the steps of:
providing a recording environment including a plurality of staging areas;
collecting at least one of an audio or an audiovisual set of data signals from at least one of the plurality of staging areas;
reviewing the collected data signal set at a production facility;
optionally editing the at least one data signal set;
approving the data signal set for distribution;
posting said data signal set on the Internet; and
repeating any of the foregoing steps.

4. The process for developing and posting audio and audiovisual footage through the Internet of claim 3, where the collecting step further comprises:
the at least one of audio or audiovisual set of data signals being a rehearsal.

5. The process for developing and posting audio and audiovisual footage through the Internet of claim 3, said posting step further comprises:
providing access of a subscription-basis to Internet users.

6. The process for developing and posting audio or audiovisual footage through the Internet of claim 3, further comprising:
providing at least one of retail access, licensing and distribution for the involved content.

7. The process for developing and posting audio or audiovisual footage through the Internet of claim 3, the providing step further comprising:
the recording studio being an automatically functional unit.

8. A product, created by the process of claim 3.

9. The process for developing and posting audio or audiovisual footage through the Internet of claim 3, the reviewing step further comprising:
packaging the resulting data and transmitting it to a desired location.

10. A process for developing audio or audiovisual footage, comprising the steps of:
providing a recording environment including at least a performance space;
collecting at least one of an audio and an audiovisual set of data signals from the at least a performance space;
processing the collected data signal set; and
distributing the footage to retail consumers.

11. The process of claim 10, wherein the distributing step further comprises using the Internet.

12. The process of claim 10, the processing step further comprising:
approving the data signal set for distribution at a location remote from the performance space.

13. The process of claim 10, further comprising:
posting said data signal set on the Internet; and
repeating the foregoing steps.

14. The process of claim 10, the collecting step further comprising the set of data signals being at least one of a practice, rehearsal, and other non-final session of a future event.

15. A method of rehearsal content management by a third party comprising at least one performer and having an Internet distribution network comprising the steps of:
the third party viewing, using a computer, at least one of audio or audiovisual signal data created by a performer; and,
the third party directing the at least one of audio or audiovisual signal data created by the performer to another location.

16. The method of claim 14, the directing step further comprising:
routing the at least one of audio or audiovisual signal data created by the performer to at least one of a production facility, an editing facility, a content management facility and the Internet.

17. The method of claim 14, wherein the routing step is done on a subscription basis with a multiplicity of users.

18. The method of claim 17, wherein the subscription is available on the Internet on at least one of a real-time, substantially real-time and time-delayed basis.

19. The method of claim 16, wherein the at least one of audio or audiovisual signal data created by the performer is transmitted at least one of in advance of, during or subsequent to a performance event for which the at least one performer is rehearsing.

20. A process for providing rehearsal content by generating at least one of audio or audiovisual data signals in a staging area comprising;
transmitting a set of data signals from a production area to a production facility and an editing site;
editing the data signals and forwarding the revised signals back to at least one of the staging area and the Internet; and
communicating the data signals to a desired set of Internet locations and a content management site.
